(19) United States
(12) Patent Application Publication
(10) Pub. No.: US 2024/0248185 A1
(43) Pub. Date: Jul. 25, 2024

(54) CORRECTION OF TEMPERATURE-RELATED MEASUREMENT ERRORS FOR TIME-OF-FLIGHT CAMERAS

(71) Applicant: BASLER AG, Ahrensburg (DE)

(72) Inventors: HANNA STOLLE, Lübeck (DE); IRIS ELLERKAMP, Lübeck (DE)

(73) Assignee: BASLER AG, Ahrensburg (DE)

(21) Appl. No.: 18/414,960

(22) Filed: Jan. 17, 2024

(30) Foreign Application Priority Data
Jan. 19, 2023 (DE) 102023101234.7

(51) Int. Cl. G01S 7/497; G01S 17/894

(52) U.S. Cl. CPC G01S 7/497; G01S 17/894

(57) ABSTRACT

A time of flight, ToF, camera system for measuring depth images of an environment is disclosed, wherein the ToF camera system includes an illumination unit comprising a light source for emitting modulated light signals for illuminating objects of the environment and a sensor unit comprising an image sensor for acquiring light signals reflected from the objects. A processing unit for generating the depth images based on the acquired reflected light signals and a correction unit for correcting temperature-related measurement errors of the generated depth images is included.

### CROSS-REFERENCE TO FOREIGN PRIORITY APPLICATION

The present application claims the benefit under 35 U.S.C. §§ 119(b), 119(e), 120, and/or 365(c) of German Application No. DE 102023101234.7 filed Jan. 19, 2023.

### FIELD OF THE INVENTION

The invention relates to a time of flight, ToF, camera system for measuring depth images of an environment and a corresponding ToF method.

### BACKGROUND OF THE INVENTION

The generation of depth images with a time of flight, ToF, camera is classified as an active method of optical 3D imaging. In contrast to passive methods, not only ambient light is used for imaging, but also light emitted by the camera. The wavelength is typically in the near infrared range so that the illumination is not visible to the human eye. The emitted light is reflected by the objects in the environment, returns to the camera, and is detected by a sensor. By restricting detection to infrared light, ambient light can be easily filtered out. The further away the object is, the more time passes between emission and detection of the light. The aim of a ToF measurement is therefore to measure this time and thus calculate the distance to the object.

Due to the high speed of light, the time differences between emission and detection are very short: light only needs approx. 3.3 ns to travel one meter. Therefore, an extremely high temporal resolution of the measurement is necessary for a good depth resolution.

In pulse modulation, the light source of the ToF camera emits a light pulse at a point in time t₀ and simultaneously starts a high-precision time measurement. If the light reflected by an object in the scene then arrives at the camera at a point in time t₁, the distance to the object can be calculated directly from the measured time of flight t₁−t₀ as d=c/2−(t₁−t₀), where c indicates the speed of light. Technically, this is not easy to realize, which is why indirect methods are often used as an alternative, in which the intensity of the emitted light is modulated and the phase shift φ is measured, which is caused by the time difference between the emitted light and the detected light. The modulation takes place either in the form of a sinusoidal oscillation or in the form of periodic sequences of rectangular pulses. This method is also referred to in the literature as continuous wave (CW) modulation.

For example, a rectangular modulated light pulse of the duration t_{P} is emitted. At the same time, a first electronic shutter of the pixel of the sensor of the ToF camera opens for the duration of the emitted light pulse. The reflected light arriving during this time is stored as the first electrical charge S₁. Now the first shutter is closed and a second electronic shutter—at the time the light source is switched off—is also opened for the duration of the light pulse t_{P}. The reflected light that arrives at the pixel during this time is stored as a second electrical charge S₂. As the light pulse is very short, this process is repeated several thousand times. The integrated electrical charges S₁ and S₂ are then read out.

The result is two partial images that show for each pixel the integrated electrical charge S₁ resp. S₂. In the S₁-image, the near objects in the scene are brighter, as less and less reflected light reaches the ToF camera as the distance increases. With the S₂-measurement, it is exactly the opposite. Here, close objects are dark because the second shutter only opens when the light has been traveling for a while. The ratio of the integrated electrical charges S₁ and S₂ therefore changes in dependence of the distance that the emitted and reflected light has traveled.

The phase shift φ can therefore be determined as follows:

$$φ = \frac{{S}_{2}}{{S}_{1} + {S}_{2}} \qquad ( 1 )$$

The distance to the object can then be calculated for each pixel as follows:

$$d = \frac{c}{2} {t}_{p} φ \qquad ( 2 )$$

where c again indicates the speed of light.

The frequency of the modulation is typically in the MHz range, so that measurements can be made for depths of up to several meters.

There are various effects that lead to a degradation of the measurement results with ToF cameras. These include to a considerable extent temperature effects. On the one hand, the ambient temperature can have an influence on the camera. This is a systematic error that can usually be corrected by calibration for a constant room temperature. Secondly, some components heat up during use, which in turn can affect the function of, for example, illumination diodes or the sensor. This is particularly relevant because the precise synchronization of the illumination cycle (light pulses) and sensor cycle (shutter) is of great importance for the depth measurement. Temperature fluctuations change the signal propagation times of the light and shutter pulses, which leads to a distance-independent error. This means that this error is a constant offset for all distances. On the other hand, the shape of the pulses themselves can also be influenced, which leads to a distance-dependent error. The measurement errors caused by temperature effects can be in the range of several centimeters (see Seiter, Johannes et al., “Correction of the temperature induced error of the illumination source in a time of flight distance measurement setup,” IEEE Sensors Applications Symposium, 2013).

Various attempts have already been made to compensate for the influence of temperature effects in a ToF camera.

In one of these approaches, an optical fiber is integrated into the ToF setup, which leads from the illumination LEDs directly to a reference pixel. The light that is detected at this pixel therefore always covers a constant distance so that the depth measured here can be used as a reference value. The correction is then made by subtracting the reference value from the measured depth data (see Seiter, Johannes et al., ibid).

Patent applications US 2021/0382153 A1 and US 2022/0026545 A1 describe a similar variant, in which correction methods using reference measurements are also presented. However, no optical fibers are used, but only the light reflected inside the camera housing is measured at a reference pixel.

Other methods use temperatures measured in the ToF camera for the correction. One example of this is the method described in U.S. Pat. No. 10,663,566 B2. There, temperatures in the ToF camera and phase offsets are measured during several heating processes and modeled with exponential functions over time. The results are used to calculate the system constant K for the linear relationship between temperature and phase in the stable state and also the time constant τ for the exponential relationship between time and temperature during heating. These are used according to Eq. (3) to estimate the phase offset P₀. The correction should work well for both the stable state and the heating process due to the consideration of the temporal changes.

$${P}_{0} \approx K \cdot ( {T}_{final} - {T}_{kalib} + τ \cdot \frac{d ( T )}{dt} ) \qquad ( 3 )$$

Such a transient, i.e., time-dependent, temperature model has the disadvantage that it requires a complex determination of the time constant τ and that also derivatives d(T)/dt have to be calculated, which impairs the stability of the method.

US 2020/0326426 A1 describes another correction option that takes into account the temperatures measured in the camera. Here, the temporal change of the temperatures is not taken into account, but a modeling of the phase offset in dependence of the temperatures at the sensor T_{Sensor} and on the illumination unit T_{Laser} is performed (see Eq. (4)). The coefficients di are determined separately for the different frequencies of the illumination modulation and also separately for the individual phase images and applied during operation.

$$f ( {T}_{Laser} , {T}_{Sensor} ) = {d}_{0} + {d}_{1} \cdot {T}_{Sensor} + {d}_{2} \cdot {T}_{Laser} + {d}_{3} \cdot {T}_{Laser}^{2} + {d}_{4} \cdot {T}_{Laser}^{3} \qquad ( 4 )$$

One of the disadvantages of this method is that it is performed on the various phase images, which leads to a high processing effort.

In view of these problems, it would therefore be desirable to provide a ToF camera system and a ToF method that enable an efficient and stable correction of temperature-related measurement errors of the generated depth images.

### SUMMARY OF THE INVENTION

The invention is based on the object of providing a time of flight, ToF, camera system that enables efficient and stable correction of temperature-related measurement errors of the generated depth images. Furthermore, the invention is based on the object of providing a corresponding ToF method.

According to a first aspect of the invention, there is provided a time of flight, ToF, camera system for measuring depth images of an environment, wherein the ToF camera system comprises:
an illumination unit comprising a light source for emitting modulated light signals for illuminating objects of the environment;
a sensor unit comprising an image sensor for acquiring light signals reflected from the objects;
a processing unit for generating the depth images based on the acquired reflected light signals; and
a correction unit for correcting temperature-related measurement errors of the depth images,
wherein the sensor unit comprises a sensor unit temperature measuring unit for measuring a current temperature at the sensor unit and/or the illumination unit comprises an illumination unit temperature measuring unit for measuring a current temperature at the illumination unit,
wherein the correction unit is adapted to perform the correcting in dependence of the current temperature at the sensor unit and/or the current temperature at the illumination unit, as well as a set exposure time and a set frame rate.

The invention is based on the inventors' knowledge that the temperature-related measurement errors of the generated depth images are influenced not only by the measured, current temperatures of the ToF camera but also by the set exposure time and the set frame rate. It has been shown that an efficient and stable correction of the temperature-related measurement errors of the generated depth images is possible if these two parameters are taken into account during correction.

It is preferred that the correcting comprises weighting a sensor unit temperature difference between the current temperature at the sensor unit and a reference temperature at the sensor unit with a sensor unit temperature correction coefficient and/or weighting an illumination unit temperature difference between the current temperature at the illumination unit and a reference temperature at the illumination unit with an illumination unit temperature correction coefficient.

It is further preferred that the correcting comprises weighting an exposure time difference between the set exposure time and a reference exposure time with an exposure time correction coefficient.

It is preferred that the correcting comprises weighting a frame rate difference between the set frame rate and a reference frame rate with a frame rate correction coefficient.

It is further preferred that the correcting comprises weighting a product of an exposure time difference between the set exposure time and a reference exposure time and a frame rate difference between the set frame rate and a reference frame rate with an exposure time frame rate correction coefficient.

It is preferred that the correcting comprises using the weighted sensor unit temperature difference and/or the weighted illumination unit temperature difference and/or the weighted exposure time difference and/or the weighted frame rate difference and/or the weighted product of the exposure time difference and the frame rate difference each as an offset value of the generated depth images.

According to a second aspect of the invention, there is provided a time of flight, ToF, camera system for measuring depth images of an environment, wherein the ToF camera system comprises:
an illumination unit comprising a light source for emitting modulated light signals for illuminating objects of the environment;
a sensor unit comprising an image sensor for acquiring light signals reflected from the objects;
a processing unit for generating the depth images based on the acquired reflected light signals; and
a correction unit for correcting temperature-related measurement errors of the generated depth images,
wherein the illumination unit comprises an illumination temperature measuring unit for measuring a current temperature at the illumination unit,
wherein the sensor unit comprises a sensor unit temperature measuring unit for measuring a current temperature at the sensor unit,
wherein the correction unit is adapted to perform the correcting in dependence of the current temperature at the illumination unit and the current temperature at the sensor unit independently of time and directly on the generated depth images.

The invention is based on the inventors' realization that the temperature-related measurement errors of the generated depth images are influenced in particular by the measured, current temperatures at the illumination unit and the sensor unit. It has been shown that the use of a transient temperature model, which requires a complex determination of a time constant C and for which also derivatives d(T)/dt have to be calculated, is not necessary for efficient and stable correction of the temperature-related measurement errors of the generated depth images, but that the correction can also be performed independently of time—i.e., without determining temperature change rates. In addition, the correction can also be performed directly on the generated depth images instead of on the various phase images. Both measures thus reduce the processing effort.

It is preferred that the correcting comprises weighting an illumination unit temperature difference between the current temperature at the illumination unit and a reference temperature at the illumination unit with an illumination unit temperature correction coefficient.

It is further preferred that the correcting comprises weighting a sensor unit temperature difference between the current temperature at the sensor unit and a reference temperature at the sensor unit with a sensor unit temperature correction coefficient.

It is preferred that the correcting comprises using the weighted illumination unit temperature difference and/or the weighted sensor unit temperature difference each as an offset value of the generated depth images.

According to both the first aspect and the second aspect, it is preferred that
the sensor unit is adapted to alternately acquire the light signals reflected from the objects with a shorter exposure time and a longer exposure time;
wherein the processing unit is adapted to generate first depth images based on the reflected light signals acquired with the shorter exposure time and second depth images based on the reflected light signals acquired with the longer exposure time and to generate the depth images based on the first depth images and the second depth images, and
wherein the correction unit is adapted to correct the temperature-related measurement errors of the first depth images and the second depth images each separately.

It is also preferred that the correction unit is adapted to perform the correcting additionally in dependence of the respective exposure time and/or a difference between the longer exposure time and the shorter exposure time.

According to a third aspect of the invention, there is provided a time of flight, ToF, method for measuring depth images of an environment, wherein the ToF method comprises:
emitting modulated light signals for illuminating objects in the environment, by a light source of an illumination unit;
acquiring light signals reflected from the objects, by an image sensor of a sensor unit;
generating the depth images based on the acquired reflected light signals, by a processing unit; and
correcting temperature-related measurement errors of the depth images, by a correction unit,
wherein the correcting is performed in dependence of a current temperature at the sensor unit measured by a sensor unit temperature measuring unit of the sensor unit and/or a current temperature at the illumination unit measured by an illumination unit temperature measuring unit of the illumination unit, as well as a set exposure time and a set frame rate.

According to a fourth aspect of the invention, there is provided a time of flight, ToF, method for measuring depth images of an environment, wherein the ToF method comprises:
emitting modulated light signals for illuminating objects in the environment, by a light source of an illumination unit;
acquiring light signals reflected from the objects, by an image sensor of a sensor unit;
generating the depth images based on the acquired reflected light signals, by a processing unit; and
correcting temperature-related measurement errors of the depth images, by a correction unit,
wherein the correcting is performed in dependence of a current temperature at the illumination unit measured by an illumination unit temperature measuring unit of the illumination unit and a current temperature at the sensor unit measured by a sensor unit temperature measuring unit of the sensor unit, independently of time and directly on the generated depth images.

It will be understood that the ToF camera systems and methods as claimed in the independent claims have similar and/or identical preferred embodiments, in particular as defined in the dependent claims.

It is to be understood that a preferred embodiment of the invention may also be any combination of the dependent claims with the corresponding independent claim.

### BRIEF DESCRIPTION OF THE DRAWINGS

Preferred embodiments of the invention are described in more detail below with reference to the accompanying Figures, wherein:

FIG. 1 shows schematically and exemplarily a setup of a ToF camera system according to the invention;

FIG. 2 shows a flow diagram illustrating a first variant of an embodiment of a ToF method according to the invention; and

FIG. 3 shows a flow diagram illustrating a second variant of the embodiment of the ToF method according to the invention.

### DETAILED DESCRIPTION OF THE EMBODIMENTS

In the Figures, identical or corresponding elements or units are each provided with identical or corresponding reference signs. If an element or unit has already been described in connection with a Figure, it may not be described in detail in connection with another Figure.

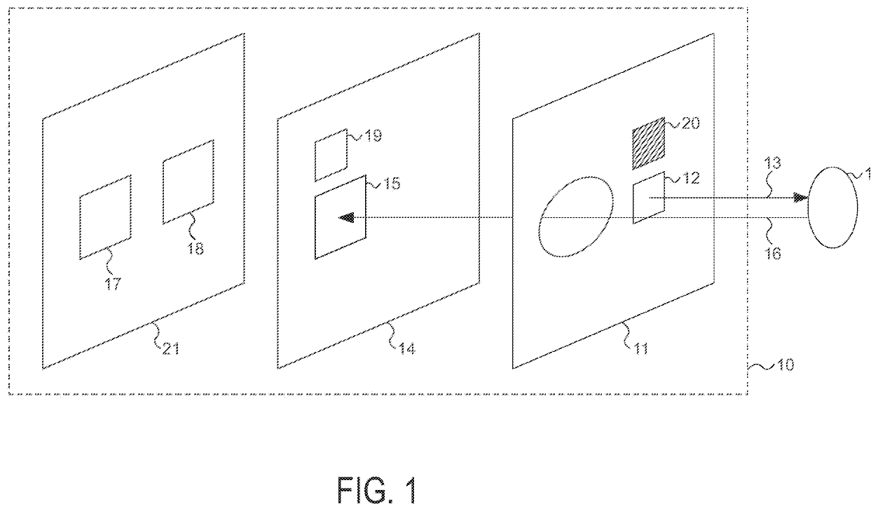

FIG. 1 shows schematically and exemplarily a setup of a time of flight, ToF, camera system 10 according to the invention for measuring depth images D of an environment. The ToF camera system 10 comprises an illumination unit 11, which comprises a light source 12 for emitting modulated light signals 13 for illuminating objects 1 of the environment, a sensor unit 14, which comprises an image sensor 15 for acquiring light signals 16 reflected from the objects 1, a processing unit 17 for generating the depth images D based on the acquired reflected light signals 16, and a correction unit 18 for correcting temperature-related measurement errors of the generated depth images D.

The light source 12 advantageously emits the light into the field of view of the ToF camera system 10. For example, LEDs (Light Emitting Diodes) or LDs (Laser Diodes), in particular VCSEL diodes (Vertical Cavity Surface Emitting Lasers) can be used. The latter are characterized by narrow bandwidths, high peak powers, and short rise and fall times. Compared to LEDs, this allows rectangular pulses to be modulated more precisely and higher pulse frequencies to be realized. In this embodiment, infrared light is used as illumination. This has the advantage that it is visually inconspicuous.

In this embodiment, the ToF camera system 10 works according to the indirect ToF method. For this purpose, it can have further elements not shown in FIG. 1. These may include: shutters for opening and closing the exposure of the image sensor 15, a pulse generator for generating first pulses for switching the light source 12, and second pulses for switching the shutters, as well as a first driver for amplifying the first pulses and outputting them to the light source 12 and a second driver for amplifying the second pulses and outputting them to the shutters. The pulse generator can be an FPGA that generates the pulses with logic standard signals. The drivers can amplify the logic standard levels so that the switching signals can switch the light source 11 or the shutters of the ToF camera system 10 with their logic standard levels. Preferably, the ToF camera system 10 also comprises a lens, also not shown in FIG. 1, which projects the light signals 16 reflected by the objects 1 onto the image sensor 15.

The image sensor 15 can be a ½″ DepthSense IMX556 from Sony, for example, which works with Backside Illuminated CMOS technology and achieves a resolution of 640×480 pixels with a pixel size of 10 μm. The generation of the depth images D by the processing unit 17 in this example is based on the phase shift between the illumination pulses and the shutter pulses at the image sensor 15. A frame consists of four micro frames, in each of which measurements take place with a 90° phase shift.

In this embodiment, the illumination unit 11 is an illumination board on which the light source 12 is arranged, and the sensor unit 14 is a sensor board on which the image sensor 15 is arranged. The processing unit 17 and the correction unit 18 are preferably arranged on a processing board 21.

In a first variant of the embodiment shown in FIG. 1, the sensor unit 14 comprises a sensor unit temperature measuring unit 19 for measuring a current temperature T_{Sen} at the sensor unit 14. In this variant, the correction unit 18 is adapted to perform the correcting in dependence of the current temperature T_{Sen} at the sensor unit 14, a set exposure time exp and a set frame rate fr.

In this variant, the correcting comprises weighting a sensor unit temperature difference ΔT_{Sen} between the current temperature T_{Sen} at the sensor unit 14 and a reference temperature T_{Sen}^{ref} at the sensor unit 14 with a sensor unit temperature correction coefficient c_{T}_{_{Sen}}.

The correcting further comprises weighting an exposure time difference Δexp between the set exposure time exp and a reference exposure time exp^{ref} with an exposure time correction coefficient cₑₓₚ.

The correcting further comprises weighting a frame rate difference Δfr between the set frame rate fr and a reference frame rate fr^{ref} with a frame rate correction coefficient c_{fr}.

In addition, the correcting comprises weighting a product of an exposure time difference Δexp between the set exposure time exp and a reference exposure time exp^{ref} and a frame rate difference Δfr between the set frame rate fr and a reference frame rate fr^{ref} with an exposure time frame rate correction coefficient c_{exp,fr}.

In this variant, the correcting comprises using the weighted sensor unit temperature difference c_{T}_{_{Sen}}·ΔT_{Sen} and/or the weighted exposure time difference cₑₓₚ·Δexp and/or the weighted frame rate difference c_{fr}·Δfr and/or the weighted product c_{exp,fr}·Δexp·Δfr of the exposure time difference Δexp and the frame rate difference Δfr each as an offset value of the generated depth images D.

It is particularly preferable that the correcting is performed in accordance with Eq. (5):

$${D}_{1} = D + {c}_{{T}_{Sen}} \cdot Δ {T}_{Sen} + {c}_{exp} \cdot Δ exp + {c}_{fr} \cdot Δ fr + {c}_{exp , fr} \cdot Δ exp \cdot Δ fr - {d}_{ref} \qquad ( 5 )$$

Herein, D₁ refers to a corrected depth image and d_{ref} is a reference measurement error that is subtracted from all measured values.

The set exposure time exp can lie within a predefined range of possible exposure times. For example, this range can be a range from 100 μs to 1000 μs. The set frame rate fr can also lie within a predefined range of possible frame rates. For example, this range can be a range from 2 fps to 30 fps.

The correction coefficients c_{T}_{_{Sen}}, cₑₓₚ, c_{fr} and c_{exp,fr} can preferably be determined in a two-step calibration procedure. In the first calibration step, the correction coefficient c_{T}_{_{Sen}} is determined. A linear relationship between the measurement error and the current temperature T_{Sen} at the sensor unit 14 is assumed, so that a correction of the measurement error is possible using Eq. (6):

$${D}_{{T}_{Sen}} = D + {c}_{{T}_{Sen}} \cdot Δ {T}_{Sen} \qquad ( 6 )$$

The correction coefficient c_{T}_{_{Sen}} (and the offset d₀) is determined using linear fits according to Eq. (7) on data from heating processes of the ToF camera system 10 and the averaged value is used.

$${Error}_{{T}_{Sen}} = {d}_{0} - {c}_{{T}_{Sen}} \cdot Δ {T}_{Sen} \qquad ( 7 )$$

According to this, there should only be a dependence of the measurement error on the exposure time exp and the frame rate fr since the measurement errors caused by the thermal settling were eliminated by the first step. In the second step, therefore, the exposure time exp and the frame rate fr are included, resulting in the above equation (5) for the first variant. The second calibration step is performed for the exposure time exp and the frame rate fr together, as a combined error dependency is assumed. For this purpose, a surface of a shape according to Eq. (8) can be fitted to the data after the sensor unit temperature correction and thus the correction coefficients cₑₓₚ, c_{fr} and c_{exp,fr} can be determined.

$${Error}_{Exp , Fr} = {d}_{ref} - {c}_{exp} \cdot Δ exp - {c}_{fr} \cdot Δ fr - {c}_{exp , fr} \cdot Δ exp \cdot Δ fr \qquad ( 8 )$$

The differences ΔT_{Sen}, Δexp and Δfr each refer to reference values from the calibration of the ToF camera system 10. For example, these can be 38.5° C. for the temperature at the sensor unit, 1000 μs for the exposure time and the maximum frame rate, e.g. 30 fps. The reference measurement error d_{ref} that the surface fit gives for these reference settings at the reference temperature is then subtracted from all measured values.

In a second variant of the embodiment shown in FIG. 1, the sensor unit 14 comprises a sensor unit temperature measuring unit 19 for measuring a current temperature T_{Sen} at the sensor unit 14, and the illumination unit 11 comprises an illumination unit temperature measuring unit 20 for measuring a current temperature T_{Ill} at the illumination unit 14. In this variant, the correction unit 18 is adapted to perform the correcting in dependence of the current temperature at the illumination unit 11 and the current temperature at the sensor unit 14. T_{Ill} on the illumination unit 11 and the current temperature T_{Sen} on the sensor unit 14 independently of time and directly on the generated depth images D.

In this variant, the correction involves weighting an illumination unit temperature difference ΔT_{Ill} between the current temperature at the illumination unit T_{Ill} and a reference temperature T_{Ill}^{ref} at the illumination unit 11 with an illumination unit temperature correction coefficient c_{T}_{_{Ill}}.

The correcting further comprises weighting a sensor unit temperature difference ΔT_{Sen} between the current temperature T_{Sen} at the sensor unit 14 and a reference temperature T_{Sen}^{ref} at the sensor unit 14 with a sensor unit temperature correction coefficient c_{T}_{_{Sen}}.

In this variant, the correcting comprises using the weighted illumination unit temperature difference c_{T}_{_{Ill}}·ΔT_{Ill} and/or the weighted sensor unit temperature difference c_{T}_{_{Sen}}·ΔT_{Sen} each as an offset value of the generated depth images D.

It is particularly preferable that the correcting is performed in accordance with Eq. (9):

$${D}_{2} = D + {c}_{{T}_{Ill}} \cdot Δ {T}_{Ill} + {c}_{{T}_{Sen}} \cdot Δ {T}_{Sen} - {d}_{ref} \qquad ( 9 )$$

Herein, D₂ refers to a corrected depth image and d_{ref} is a reference measurement error that is subtracted from all measured values.

The correction coefficients c_{T}_{_{Sen}} and c_{T}_{_{Ill}} can preferably be determined in a one-step calibration procedure. For this purpose, they are determined by means of a fit of the entire transient data according to Eq. (10):

$${Error}_{{T}_{Ill , Sen}} = {d}_{ref} - {c}_{{T}_{Ill}} \cdot Δ {T}_{Ill} + {c}_{{T}_{Sen}} \cdot Δ {T}_{Sen} \qquad ( 10 )$$

The differences ΔT_{Ill} and ΔT_{Sen} again refer to reference values from the calibration of the ToF camera system 10. For example, these can be 38.5° C. for the temperature at the sensor unit, 1000 μs for the exposure time and the maximum frame rate, e.g. 30 fps. The reference measurement error d_{ref} that the surface fit gives for these reference settings at the reference temperature is then subtracted from all measured values.

According to both the first variant and the second variant, it is possible that the sensor unit 14 is adapted to alternately acquire the light signals 16 reflected from the objects 1 with a shorter exposure time exp_{S} and a longer exposure time exp_{L};
wherein the processing unit 17 is adapted to generate first depth images D_{S} based on the reflected light signals 16 acquired with the shorter exposure time exp_{S} and second depth images D_{L} based on the reflected light signals 16 acquired with the longer exposure time exp_{L} and to generate the depth images D based on the first depth images D_{S} and the second depth images D_{L}, and
wherein the correction unit 18 is adapted to correct the temperature-related measurement errors of the first depth images D_{S} and the second depth images D_{L} each separately.

In addition, it is possible that the correction unit 18 is adapted to perform the correction additionally in dependence of the respective exposure times exp_{S} and/or exp_{L} and/or a difference Δexp_{LS} between the longer exposure time exp_{L} and the shorter exposure time exp_{S}.

In particular, the additional correction could be made following the correction of the first variant (Eq. (5)) in accordance with Eq. (11):

$${D}_{1 , L / S} = {D}_{1} + {c}_{{exp}_{LS}} \cdot ΔΔ {exp}_{LS} + {c}_{{exp}_{L / S}} \cdot Δ {exp}_{L / S} \qquad ( 11 )$$

Herein, D_{1,L/S} refers to a corrected first or second depth image, cₑₓₚ_{_{LS}} is a longer-shorter exposure time difference correction coefficient, ΔΔexp_{LS} is the difference between (i) the difference Δexp_{LS} between the longer exposure time exp_{L} and the shorter exposure time exp_{S} and (ii) a reference exposure time exp_{LS}^{ref}, Δexp_{L/S} is a difference between the longer exposure time exp_{L} or the shorter exposure time exp_{S} and a reference exposure time exp^{ref}, and cₑₓₚ_{_{L/S}} is an associated exposure time correction coefficient.

Alternatively, the additional correction could be made following the correction of the second variant (Eq. (9)) in accordance with Eq. (12):

$${D}_{2 , L / S} = {D}_{2} + {c}_{{exp}_{L / S}} \cdot Δ {exp}_{L / S} \qquad ( 12 )$$

Herein, D_{2,L/S} refers to a corrected first or second depth image, Δexp_{L/S} is a difference between the longer exposure time exp_{L} or the shorter exposure time exp_{S} and a reference exposure time exp_{L/S}^{ref} and cₑₓₚ_{_{L/S}} is an associated exposure time correction coefficient.

The correction coefficients cₑₓₚ_{_{L/S}} and cₑₓₚ_{_{L/S}} can preferably each be determined in a one-step calibration procedure. For this purpose, they are determined by means of a fit of the data corrected with the first variant or the second variant in accordance with Eqs. (13) or (14):

$${Error}_{1 , LS} = - {c}_{{exp}_{LS}} \cdot Δ {exp}_{LS} - {c}_{{exp}_{L / S}} \cdot Δ {exp}_{L / S} \qquad ( 13 )$$

$$resp .$$

$${Error}_{2 , LS} = - {c}_{{exp}_{L / S}} \cdot Δ {exp}_{L / S} \qquad ( 14 )$$

The calibration can also be performed together with the calibration according to the first variant or according to the second variant. If the calibration is performed together with the calibration according to the first variant, the associated exposure time correction coefficient cₑₓₚ_{_{L/S}} can also be taken into account directly in the exposure time correction coefficient cₑₓₚ In this case, the last term of Eq. (11) can be omitted.

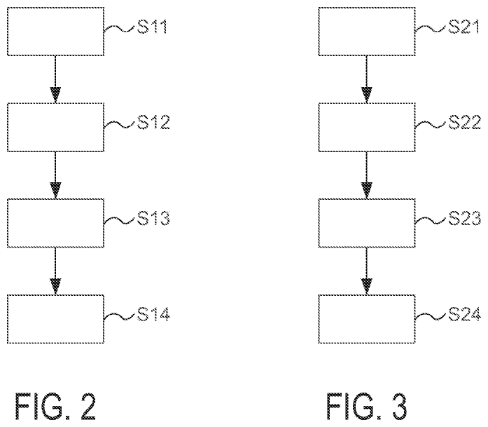

FIG. 2 shows schematically and exemplarily a flow diagram illustrating a first variant of an embodiment of a ToF method according to the invention for measuring depth images D of an environment. The ToF method can, for example, be performed with the ToF camera system 10 shown in FIG. 1 according to the first variant.

In step S11, modulated light signals 13 are emitted for illuminating objects 1 in the environment. This is done by a light source 12 of an illumination unit 11.

In step S12, light signals 16 reflected from the objects 1 are acquired. This is done by an image sensor 15 of a sensor unit 14.

In step S13, the depth images D are generated are generated based on the acquired reflected light signals 16. This is done by a processing unit 17.

In step S14, temperature-related measurement errors of the depth images D are corrected. This is done by a correction unit 18.

In this variant, the correcting is performed in dependence of a current temperature T_{Sen} measured by a sensor unit temperature measuring unit 19 of the sensor unit 14 at the sensor unit 14, a set exposure time exp and a set frame rate fr.

FIG. 3 shows schematically and exemplarily a flow diagram illustrating a second variant of the embodiment of the ToF method according to the invention for measuring depth images D of an environment. The ToF method can, for example, be performed with the ToF camera system 10 shown in FIG. 1 according to the second variant.

In step S21, modulated light signals 13 are emitted for illuminating objects 1 in the environment. This is done by a light source 12 of an illumination unit 11.

In step S22, light signals 16 reflected from the objects 1 are acquired. This is done by an image sensor 15 of a sensor unit 14.

In step S23, the depth images D are generated are generated based on the acquired reflected light signals 16. This is done by a processing unit 17.

In step S24, temperature-related measurement errors of the depth images D are corrected. This is done by a correction unit 18.

In this variant, the correcting is performed in dependence of a current temperature T_{Ill} at the illumination unit 11 measured by an illumination unit temperature measuring unit 20 of the illumination unit 11 and a current temperature T_{Sen} at the sensor unit 14 measured by a sensor unit temperature measuring unit 19 of the sensor unit 14 independently of time and directly on the generated depth images D.

In the ToF camera system 10 according to the invention, it is preferably provided that depth measurements for large distances with a good depth resolution are made possible by using two different modulation frequencies. This results in four different recording modes: In this variant, the correction is performed in dependence of a current temperature T_{Ill} at the illumination unit 11 measured by an illumination unit temperature measuring unit 20 of the illumination unit 11 and a current temperature T_{Sen} at the sensor unit 14 measured by a sensor unit temperature measuring unit 19 of the sensor unit 14.

Whereas in the first variant of the embodiment shown in FIG. 1, the sensor unit 14 comprises a sensor unit temperature measuring unit 19 for measuring a current temperature T_{Sen} at the sensor unit 14, wherein the correction unit 18 is adapted to perform the correcting in dependence of the current temperature T_{Sen} at the sensor unit 14, a set exposure time exp and a set frame rate fr, further variants can be provided.

For example, in a third variant of the embodiment shown in FIG. 1, the illumination unit 11 may comprise an illumination unit temperature measuring unit 20 for measuring a current temperature T_{Ill} at the illumination unit 11, wherein the correction unit 18 is adapted to perform the correcting in dependence of the current temperature T_{Ill} at the illumination unit 11, as well as a set exposure time exp and a set frame rate fr.

In this variant, correcting comprises weighting an illumination unit temperature difference ΔT_{Ill} between the current temperature T_{Ill} at the illumination unit 11 and a reference temperature T_{Ill}^{ref} if at the illumination unit 11 with an illumination unit temperature correction coefficient c_{T}_{_{Ill}}.

In this variant, the correcting comprises using the weighted illumination unit temperature difference c_{T}_{_{Ill}}·ΔT_{Ill} and/or the weighted exposure time difference cₑₓₚ·Δexp and/or the weighted frame rate difference c_{fr}·Δfr and/or the weighted product c_{exp,fr}·Δexp·Δfr of the exposure time difference Δexp and the frame rate difference Δfr each as an offset value of the generated depth images D.

It is particularly preferable that the correcting is performed according to Eq. (15):

$${D}_{3} = D + {c}_{{T}_{Ill}} \cdot Δ {T}_{Ill} + {c}_{exp} \cdot Δ exp + {c}_{fr} \cdot Δ fr + {c}_{exp , fr} \cdot Δ exp \cdot Δ fr - {d}_{ref} \qquad ( 15 )$$

Herein, D₃ refers to a corrected depth image and d_{ref} is a reference measurement error that is subtracted from all measured values.

In a fourth variant of the embodiment shown in FIG. 1, the sensor unit 14 may comprise a sensor unit temperature measuring unit 19 for measuring a current temperature T_{Sen} at the sensor unit 14, and the illumination unit 11 may comprise an illumination unit temperature measuring unit 20 for measuring a current temperature T_{Ill} at the illumination unit 11, wherein the correction unit 18 is adapted to perform the correcting in dependence of the current temperature T_{Sen} at the sensor unit 14 and the current temperature T_{Ill} at the illumination unit 11, as well as a set exposure time exp and a set frame rate fr.

In this variant, the correcting comprises weighting a sensor unit temperature difference ΔT_{Sen} between the current temperature T_{Sen} at the sensor unit 14 and a reference temperature T_{Sen}^{ref} at the sensor unit 14 with a sensor unit temperature correction coefficient c_{T}_{_{Sen}} and weighting an illumination unit temperature difference ΔT_{Ill} between the current temperature at the illumination unit T_{Ill} and a reference temperature T_{Ill}^{ref} at the illumination unit 11 with an illumination unit temperature correction coefficient c_{T}_{_{Ill}}.

In this variant, the correcting comprises using the weighted sensor unit temperature difference c_{T}_{_{Sen}}·ΔT_{Sen} and/or the weighted illumination unit temperature difference c_{T}_{_{Ill}}·ΔT_{Ill} and/or the weighted exposure time difference cₑₓₚ·Δexp and/or the weighted frame rate difference c_{fr}·Δfr and/or the weighted product c_{exp,fr}·Δexp·Δfr of the exposure time difference Δexp and the frame rate difference Δfr each as an offset value of the generated depth images D.

It is particularly preferable that the correcting is performed according to Eq. (16):

$${D}_{4} = D + {c}_{Sen} \cdot Δ {T}_{Sen} + {c}_{{T}_{Ill}} \cdot Δ {T}_{Ill} + {c}_{exp} \cdot Δ exp + {c}_{fr} \cdot Δ fr + {c}_{exp , fr} \cdot Δ exp \cdot Δ fr - {d}_{ref} \qquad ( 16 )$$

Herein, D₄ refers to a corrected depth image and d_{ref} is a reference measurement error that is subtracted from all measured values.

The following preferably applies to all variants of the embodiment shown in FIG. 1:

On the one hand, Long Range Fast Mode (LRFM) can only be used for measurements with, for example, 15 MHz, so that distances of up to 10 m can be measured with a low depth resolution. On the other hand, Short Range Fast Mode (SRFM) can be used, for example, with only 100 MHz pulses, in which a significantly better depth resolution is achieved, but which can only be used for distances up to 1.5 m. For objects further away, the results are ambiguous, as a distance of 1.5 m, for example, provides the same phase shift as a distance of 3 m or 4.5 m. Combining images of both frequencies results in the long range mode (LR), which can be used to measure depths of up to 10 m with the better resolution of 100 MHz. Here, the result of the 15 MHz measurement is only used to determine the 1.5 m range in which the distance is located. The result of the 100 MHz measurement is then added to the starting point of this range (e.g., 1.5 m, 3 m, 4.5 m, . . . ). Finally, there is the short range mode (SR), in which the images of both frequencies are also combined, but only distances up to 1.5 m are measured.

For the calibration of the ToF camera system 10, for example, the following data sets can be used, each of which was created with all four recording modes (LR, LRFM, SR, SRFM):

Exposure time data sets: With a fixed frame rate, images are taken with different exposure times that cover the entire range of possible settings (e.g. 100 μs to 1000 μs). For each parameter setting, the measurement consists of a heating process and a measurement on a linear axis. During the heating process (settling), the ToF camera system 10 is in a fixed position and images are recorded over a certain period of time (approx. 30-45 min). After heating up, the ToF camera system should have settled and the entire axis is moved once in 5 cm steps and an image is taken at each position. For each image, the measured distance averaged over an image section, the actual distance and the current temperatures measured in the ToF camera system 10 are saved both during the settling process and during the axis measurement. Two data sets are recorded, one at 20 fps (LR, SR) or 30 fps (LRFM, SRFM) and one at 10 fps (LR, SR) or 15 fps (LRFM, SRFM).

Frame rate data sets: Here, the frame rates are varied from 2 fps to 20 fps (or up to 30 fps in fast mode) with a fixed exposure time. Otherwise, the procedure is the same as for exposure time data sets. Here too, two data sets are created, e.g., once with 550 μs and once with 1000 μs exposure time.

Validation data sets: These data sets each consist of ten series of images with different combinations of exposure times and frame rates. These measurements are not taken into account when calculating the correction coefficients, but are used afterwards to check the quality of the correction. A data set is recorded in which a 45-minute warm-up was performed before each axis measurement, and the same data set is recorded again without a warm-up.

In the claims, the words “having” and “comprising” do not exclude other elements or steps and the indefinite article “a” does not exclude a plurality.

A single unit or device may perform the functions of several elements listed in the claims. The fact that individual functions and/or elements are listed in different dependent claims does not mean that a combination of these functions and/or elements cannot also be advantageously used.

Processes such as the generating of the depth images D based on the acquired reflected light signals 16 and the correcting of temperature-related measurement errors of the depth images D et cetera, which are performed by one or more units or devices, may also be performed by another number of units or devices. These operations may be implemented as program code of a computer program and/or as corresponding hardware.

A computer program may be stored and/or distributed on a suitable medium, such as an optical storage medium or a solid-state storage medium, which is distributed together with or as part of other hardware. However, the computer program may also be distributed in other forms, such as via the Internet or other telecommunications systems.

The reference signs in the claims are not to be understood in such a way that the object and the scope of protection of the claims would be restricted by these reference signs.

In summary, a time of flight, ToF, camera system for measuring depth images of an environment is presented, wherein the ToF camera system comprises: an illumination unit comprising a light source for emitting modulated light signals for illuminating objects of the environment; a sensor unit comprising an image sensor for acquiring light signals reflected from the objects; a processing unit for generating the depth images based on the acquired reflected light signals; and a correction unit for correcting temperature-related measurement errors of the generated depth images.

1.-14. (canceled)

15. A time of flight, ToF, camera system for measuring depth images of an environment, wherein the ToF camera system comprises:
an illumination unit comprising a light source for emitting modulated light signals for illuminating objects of the environment;
a sensor unit comprising an image sensor for acquiring light signals reflected from the objects;
a processing unit for generating the depth images based on the acquired reflected light signals; and
a correction unit for correcting temperature-related measurement errors of the depth images;
wherein the sensor unit comprises a sensor unit temperature measuring unit for measuring a current temperature (T_{Sen}) at the sensor unit and/or the illumination unit comprises an illumination unit temperature measuring unit for measuring a current temperature (T_{Ill}) at the illumination unit; and
wherein the correction unit is adapted to perform the correcting in dependence of the current temperature (T_{Sen}) at the sensor unit and/or the current temperature (T_{Ill}) at the illumination unit, as well as a set exposure time (exp) and a set frame rate (fr).

16. The ToF camera system according to claim 15, wherein the correcting comprises weighting a sensor unit temperature difference (ΔT_{Sen}) between the current temperature (T_{Sen}) at the sensor unit and a reference temperature (T_{Sen}^{ref}) at the sensor unit with a sensor unit temperature correction coefficient (c_{T}_{_{Sen}}) and/or weighting an illumination unit temperature difference (ΔT_{Ill}) between the current temperature at the illumination unit (T_{Ill}) and a reference temperature (T_{Ill}^{ref}) at the illumination unit with an illumination unit temperature correction coefficient (c_{T}_{_{Ill}}).

17. The ToF camera system according to claim 15, wherein the correcting comprises weighting an exposure time difference (Δexp) between the set exposure time (exp) and a reference exposure time (exp^{ref}) with an exposure time correction coefficient (cₑₓₚ).

18. The ToF camera system according to claim 15, wherein the correcting comprises weighting a frame rate difference (Δfr) between the set frame rate (fr) and a reference frame rate (fr^{ref}) with a frame rate correction coefficient (c_{fr}).

19. The ToF camera system according to claim 15, wherein the correcting comprises weighting a product of an exposure time difference (Δexp) between the set exposure time (exp) and a reference exposure time (exp^{ref}) and a frame rate difference (Δfr) between the set frame rate (fr) and a reference frame rate (fr^{ref}) with an exposure time frame rate correction coefficient (c_{exp,fr}).

20. The ToF camera system according to claim 15, wherein the correcting comprises using:
the weighted sensor unit temperature difference (c_{T}_{_{Sen}}·ΔT_{Sen});
the weighted illumination unit temperature difference (c_{T}_{_{Ill}}·ΔT_{Ill});
the weighted exposure time difference (cₑₓₚ·Δexp);
the weighted frame rate difference (c_{fr}·Δfr); and/or
the weighted product (c_{exp,fr}·Δexp·Δfr) of the exposure time difference (Δexp) and the frame rate difference (Δfr) each as an offset value of the generated depth images (D).

21. The ToF camera system according to claim 15, wherein:
the sensor unit is adapted to alternately acquire the light signals reflected from the objects with a shorter exposure time (exp_{S}) and a longer exposure time (exp_{L});
the processing unit is adapted to generate first depth images (D_{S}) based on the reflected light signals acquired with the shorter exposure time (exp_{S}) and second depth images (D_{L}) based on the reflected light signals acquired with the longer exposure time (exp_{L}) and to generate the depth images (D) based on the first depth images (D_{S}) and the second depth images (D_{L}); and
the correction unit is adapted to correct the temperature-related measurement errors of the first depth images (D_{S}) and the second depth images (D_{L}) each separately.

22. A time of flight, ToF, camera system for measuring depth images (D) of an environment, wherein the ToF camera system comprises:
an illumination unit comprising a light source for emitting modulated light signals for illuminating objects of the environment;
a sensor unit comprising an image sensor for acquiring light signals reflected from the objects;
a processing unit for generating the depth images (D) based on the acquired reflected light signals; and
a correction unit for correcting temperature-related measurement errors of the generated depth images (D);
wherein the illumination unit comprises an illumination unit temperature measuring unit for measuring a current temperature (T_{Ill}) at the illumination unit;
wherein the sensor unit comprises a sensor unit temperature measuring unit for measuring a current temperature (T_{Sen}) at the sensor unit; and
wherein the correction unit is adapted to perform the correcting in dependence of the current temperature (T_{Ill}) at the illumination unit and the current temperature (T_{Sen}) at the sensor unit independently of time and directly on the generated depth images (D).

23. The ToF camera system according to claim 22, wherein the correcting comprises weighting an illumination unit temperature difference (ΔT_{Ill}) between the current temperature at the illumination unit (T_{Ill}) and a reference temperature (T_{Ill}^{ref}) at the illumination unit with an illumination unit temperature correction coefficient (c_{T}_{_{Ill}}).

24. The ToF camera system according to claim 22, wherein said correcting comprises weighting a sensor unit temperature difference (ΔT_{Sen}) between the current temperature (T_{Sen}) at the sensor unit and a reference temperature (Tₛₑₙ^{ref}) at the sensor unit with a sensor unit temperature correction coefficient (c_{T}_{_{Sen}}).

25. The ToF camera system according to claim 22, wherein the correcting comprises using the weighted illumination unit temperature difference (c_{T}_{_{Ill}}·ΔT_{Ill}).

26. The ToF camera system according to claim 22, wherein the weighted sensor unit temperature difference (c_{T}_{_{Sen}}·ΔT_{Sen}) each as an offset value of the generated depth images (D).

27. The ToF camera system according to claim 22, wherein:
the sensor unit is adapted to alternately acquire the light signals reflected from the objects with a shorter exposure time (exp_{S}) and a longer exposure time (exp_{L});
the processing unit is adapted to generate first depth images (D_{S}) based on the reflected light signals acquired with the shorter exposure time (exp_{S}) and second depth images (D_{L}) based on the reflected light signals acquired with the longer exposure time (exp_{L}) and to generate the depth images (D) based on the first depth images (D_{S}) and the second depth images (D_{L}); and
the correction unit is adapted to correct the temperature-related measurement errors of the first depth images (D_{S}) and the second depth images (D_{L}) each separately.

28. The ToF camera system according to claim 27, wherein the correction unit is adapted to perform the correcting additionally in dependence of the respective exposure time (exp_{S}; exp_{L}).

29. The ToF camera system according to claim 27, wherein the correction unit is adapted to perform the correcting additionally in dependence of the respective difference (Δexp_{LS}) between the longer exposure time (exp_{L}) and the shorter exposure time (exp_{S}).

30. A time of flight, ToF, method for measuring depth images (D) of an environment,
wherein the ToF method comprises the steps of:
emitting modulated light signals for illuminating objects of the environment, by a light source of an illumination unit;
acquiring light signals reflected from the objects, by an image sensor of a sensor unit;
generating the depth images (D) based on the acquired reflected light signals, by a processing unit; and
correcting temperature-related measurement errors of the depth images (D), by a correction unit;
wherein the correction is performed in dependence of a current temperature (T_{Sen}) at the sensor unit measured by a sensor unit temperature measuring unit of the sensor unit and/or a current temperature (T_{Ill}) at the illumination unit measured by an illumination unit temperature measuring unit (20) of the illumination unit, as well as a set exposure time (exp) and a set frame rate (fr).

31. A time of flight, ToF, method for measuring depth images (D) of an environment, the ToF method comprising the steps of:
emitting modulated light signals for illuminating objects of the environment, by a light source of an illumination unit;
acquiring light signals reflected from the objects, by an image sensor of a sensor unit;
generating the depth images (D) based on the acquired reflected light signals, by a processing unit; and
correcting the temperature-related measurement errors of the depth images (D), using a correction unit;
wherein the correction is performed in dependence of a current temperature (T_{Ill}) at the illumination unit measured by an illumination unit temperature measuring unit of the illumination unit and a current temperature (T_{Sen}) at the sensor unit measured by a sensor unit temperature measuring unit of the sensor unit independently of time and directly on the generated depth images (D).

32. The ToF method according to claim 31, wherein the correcting comprises the step of weighting an exposure time difference (Δexp) between the set exposure time (exp) and a reference exposure time (exp^{ref}) with an exposure time correction coefficient (cₑₓₚ).

33. The ToF method according to claim 31, wherein the correcting comprises weighting a frame rate difference (Δfr) between the set frame rate (fr) and a reference frame rate (fr^{ref}) with a frame rate correction coefficient (c_{fr}).

34. The ToF method according to claim 31, wherein the correcting comprises weighting a product of an exposure time difference (Δexp) between the set exposure time (exp) and a reference exposure time (exp^{ref}) and a frame rate difference (Δfr) between the set frame rate (fr) and a reference frame rate (fr^{ref}) with an exposure time frame rate correction coefficient (c_{exp,fr}).
